(19) United States
(12) Patent Application Publication
(10) Pub. No.: US 2015/0217689 A1
(43) Pub. Date: Aug. 6, 2015

(54) Controlling an Interior Illumination Device for Warning a Motor Vehicle User of a Risk of Collision

(71) Applicant: Daimler AG, Stuttgart (DE)

(72) Inventors: Michael Frik, Reutlingen (DE); Holger Grossmann, Fellbach (DE); Thorsten Hoermann, Sindelfingen (DE)

(21) Appl. No.: 14/420,013

(22) PCT Filed: Jul. 18, 2013
(86) PCT No.: PCT/EP2013/002136

§ 371 Date: Feb. 6, 2015

(30) Foreign Application Priority Data
Aug. 8, 2012 (DE) 10 2012 015753.3

(51) Int. Cl. B60Q 9/00

(52) U.S. Cl. CPC B60Q 9/008; B60Q 2500/00

(57) ABSTRACT

A user of a motor vehicle is warned of a risk of collision of the motor vehicle with an object by determining the risk of collision and warning the user by way of an interior lighting device provided to illuminate an interior of the motor vehicle.

### BACKGROUND AND SUMMARY OF THE INVENTION

Exemplary embodiments of the invention relate to a method to warn a user of a motor vehicle of a risk of collision of the motor vehicle with an object as well as a motor vehicle having an interior, an interior lighting device to illuminate the interior, a control device, by means of which an illumination state of the interior lighting device is able to be controlled and a sensor device, by means of which a risk of collision of the motor vehicle with an object is able to be determined.

Methods and assistance systems to warn a user of a motor vehicle of a risk of collision with an object are known. In particular, so-called parking assistants are known which signal an approach of the motor vehicle to an object by aural and/or optical signals. The approach is determined by suitable sensor devices, for example ultrasound sensors, wherein the aural and/or optical warning to a user of the motor vehicle is emitted based on corresponding sensor signals. Furthermore, systems are known that depict surroundings of the motor vehicle to the user, for example in the form of an illustration of surroundings of the motor vehicle, wherein the objects triggering the risk of collision are able to be recognized for the user of the motor vehicle.

German patent document DE 10 2005 023 002 A1 discloses a door opening system in which the motor vehicle doors are swiveled open by means of a controllable drive unit. When opening the door, the environment is scanned with at least one sensor in the vehicle door and the distances to objects situated in the surrounding region are measured. While opening the door the current distance between the opening door and the adjacent objects is continuously measured. The distance measurement is able to be implemented from the sensor signals and the geometric data of the motor vehicle door as well as from the installation location of the sensor, using a microcontroller of the software implemented for this purpose. The sequential control implemented in the microcontroller is furthermore connected to be able to communicate with an operating unit. The operating unit contains an actuating element for each door to be opened using the system, with which the driver of the motor vehicle can start and initiate the sequential control in the microcontroller, for example by pressing a button. Using the sequential control, the controllable drive unit of the door opening system is controlled via a communication connection and the door is opened until either a safety distance to an obstacle situated in the swivel region of the motor vehicle door is reached or until the door is completely open.

German patent document DE 10 2008 036 009 A1 discloses a method for the protection of a vehicle from a collision in the area of parking and maneuvering, wherein the vehicle has environment sensors for the detection of objects in the environment of the vehicle. The method involves detecting the sensor information of the environment sensors of the vehicle, creating an environment map from the sensor information of the environment sensors, determining the individual movement of the vehicle, and determining the collision probability of the vehicle with environment objects situated in the surroundings of the vehicle from the environment objects formed in the environment map, considering the individual movement of the vehicle. Therein, a vehicle is understood here in particular to be a motor vehicle or a motor vehicle combination, i.e. a motor vehicle with a trailer.

Exemplary embodiments of the present invention are directed to warning a user of a motor vehicle of a risk of collision of the motor vehicle with an object in a more targeted manner, more discretely and/or with an increased perception of value, in particular to provide a possibility to enable such a warning with the aid of functional elements already installed in the motor vehicle, in particular for a case in which the risk of collision emerges from an operation of a door of the motor vehicle.

Specifically, exemplary embodiments of the present invention are directed to a method for warning a user of a motor vehicle of a risk of collision with an object with a determination of the risk of collision in that a warning of the user of the risk of collision occurs by means of an interior lighting device provided to illuminate an interior of the motor vehicle. Advantageously, the warning occurs using the interior lighting device already provided. An interior lighting device can be understood as any possibility for illumination of the interior provided in the motor vehicle, in particular an interior light, a background light, an ambient light and/or similar. By interior lighting device provided to illuminate it can be understood that this is provided specifically for the purpose of illuminating the interior, so explicitly not in the sense of a signal and/or warning light, which likewise emits light in the interior of the motor vehicle for signaling, but is not provided for the purpose of the illumination of the interior. Fundamentally, the interior lighting device provided for the purpose of illuminating the interior can be understood as the sum of all light provided to generate an atmosphere and/or a certain light in the interior. Advantageously, the interior lighting device is already provided on the motor vehicle, wherein an illumination state of the interior lighting device is able to be adjusted, in particular a brightness, a light color and/or similar. Advantageously, this interior lighting device can also be used to warn the user of a risk of collision, such that this is used not only for illumination of the interior and/or to generate a certain atmosphere, but also to reproduce a corresponding warning message to warn the user.

Advantageously, with the aid of different colors, a good signaling of the risk of collision can take place.

Advantageously, the colors red and green are known ubiquitously as signal colors for high risk=red and low risk=green. Advantageously, the signaling of the risk of collision can thus occur well and intuitively. If necessary, a transition from the red shade in a yellow shade into a green shade can occur if the risk of collision decreases and a transition from the green shade into the yellow shade into the red shade if the risk of collision increases. An increase and/or decrease of the risk of collision can occur, in particular with the aid of a magnitude of the risk of collision which describes the risk of collision, in particular by means of a distance. Therein, a decreasing or a comparably shorter distance can be equated to a high risk of collision and an increasing distance and/or a comparably large distance can be equated to a small risk of collision.

Advantageously, the change of the light intensity signals the risk of collision in a simple manner. It is conceivable to modulate the light intensity and/or to increase and/or it and/or to decrease it depending on the risk of collision, in particular to provide a flashing and/or flaring of the interior lighting device.

Advantageously, the threatening risk of collision can be perceived by the user of the motor vehicle in an intuitive manner.

Advantageously, further information can be transferred to the user using the change and/or illumination of the determined illumination location. Furthermore, in particular advantageously, a discrete informing of the user can occur, in particular such that further passengers of the motor vehicle cannot or can only very weakly perceive the signaling, in particular are not disturbed by this.

Advantageously, a direction in which the object is located relative to the motor vehicle can be signaled to the user by the determination and/or selection of the illumination location. Advantageously, the expected collision location of the motor vehicle with the object can be perceived and/or made out by the user by means of the determined illumination location. In particular it is conceivable that the interior is almost see-through, such that the object threatening to collide with the motor vehicle is depicted virtually in the interior. For this purpose, the interior lighting device can have a surface lighting device that is separately controlled in color and/or intensity, in particular is able to be controlled such that the determined illumination location is able to be illuminated. Alternatively or additionally, the illumination of the determined illumination location can occur by means of alignable light sources and/or a plurality of already directed and separately controlled light sources, for example of a light array. In particular, the illumination location is selected such that this is arranged in the interior of the motor vehicle on a side of an outer skin of the motor vehicle opposite the object.

Advantageously the signaling can occur where the user of the motor vehicle triggers the risk. In the example of a door, in particular a side door of the motor vehicle, it is possible that an operation, so an opening and/or closing of the door, triggers the collision with the object. For this case, in which the user increases the risk of collision by operation of the door, advantageously this risk of collision can be precisely signaled there, where the user triggers this, in particular surrounding and/or adjacent to the operating element which he operates to open and/or close the door. Advantageously, if necessary, a line of sight of the user is also directed to the operating element, as the user usually searches for this first by sight and only then operates it. Furthermore, it is often the case that on opening, the line of sight first remains on the operating element for a while, so the actual source of the risk is not immediately perceived, wherein even in such cases where the warning can advantageously be very well perceived.

Advantageously, the superimposing of the warning message in the external mirrors additionally occurs, in particular if a high surrounding light intensity is present, in particular if daylight is present, such that a perception of the warning can occur more clearly. Advantageously, systems to superimpose warning messages, in particular in the form of so-called blind spot assistances, if necessary, are also already present on correspondingly equipped motor vehicles. Advantageously, this signaling means which is already present can additionally be used to superimpose the warning message to warn of the risk of collision.

Exemplary embodiments of the present invention are also directed to a motor vehicle having an interior, an interior lighting device to illuminate the interior, a control device, by means of which an illumination state of the interior lighting device is able to be controlled, a sensor device, by means of which a risk of collision of the motor vehicle with an object is able to be determined, in that the illumination state is additionally able to be controlled depending on the risk of collision to warn the user of the risk of collision. Advantageously, the user of the motor vehicle can be warned of the risk of collision by means of the interior lighting device that is already present. For this purpose, the illumination state is advantageously able to be controlled not only for the adjustment of a certain brightness, color and/or to generate an atmosphere, but also additionally depending on the risk of collision. Advantageously, the interior lighting device thus fulfils two functions, in particular the illumination of the interior and the warning of the risk of collision. The motor vehicle is, in particular, configured, arranged, constructed and/or equipped with a software to implement a method described above. In this respect, the advantages described above result.

Further advantages, features and details result from the description below in which—if necessary with reference to the drawing—at least one exemplary embodiment is described in detail. Features which are described and/or depicted figuratively form the subject matter of the invention alone or in any useful combination, if necessary also independently of the claims, and can, in particular, additionally also be the subject matter of one or more separate application(s). Identical, similar and/or functionally identical parts are provided with the same reference numerals.

### BRIEF DESCRIPTION OF THE DRAWING FIGURES

Herein are shown:

FIG. 1 a schematic top view onto a motor vehicle having an interior lighting device and a sensor device;

FIG. 2 a schematic view from the inside of a door of the motor vehicle depicted in FIG. 1;

FIG. 3 a schematic view of a side wall from the inside of the motor vehicle depicted in FIG. 1; and

FIG. 4 a flow diagram of a method to warn a user of the motor vehicle depicted in FIGS. 1-3 of a risk of collision of the motor vehicle with an object.

### DETAILED DESCRIPTION

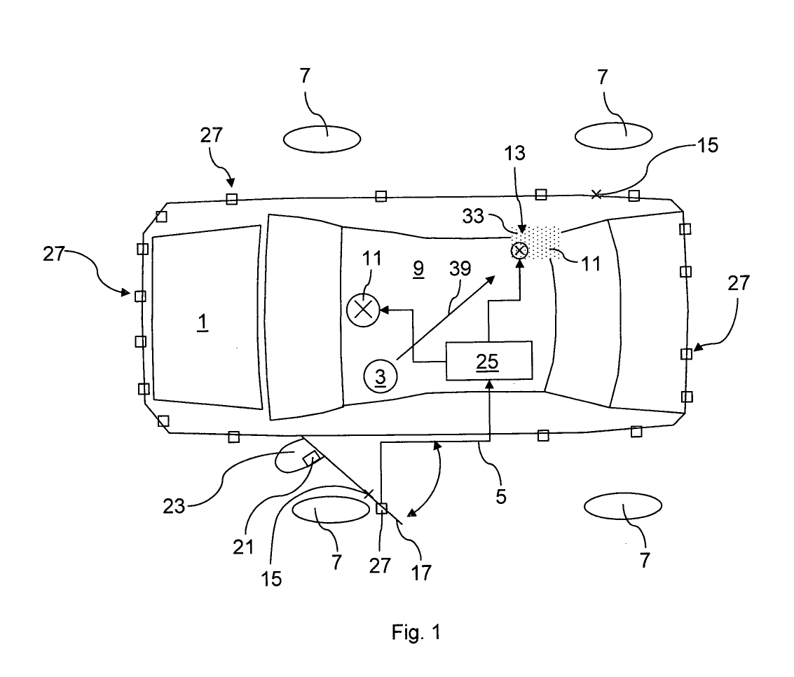

FIG. 1 shows a schematic top view onto a motor vehicle 1, which is used by a user 3. The motor vehicle 1 is situated in a situation of stationary traffic, alternatively or additionally in a situation of slow traffic, in particular of a maneuvering and/or parking operation. Slow traffic can be understood, in particular, to be traffic states with speeds <30 km/h, in particular <15 km/h, in particular <10 km/h, in particular <5 km/h. In the depiction according to FIG. 1, the motor vehicle 1 is, for example, situated in a parking space, which is surrounded on four sides by pillar-like objects 7, which corresponds to slow traffic for driving into and/or out of the parking space and stationary traffic for embarking and/or disembarking Therein a risk of collision 5 is issued from the objects 7.

The motor vehicle has a sensor device 27 for determining the risk of collision 5 with the objects 7. The sensor device 27 has a plurality of individual sensors, which are symbolized in FIG. 1 by squares. The sensors of the sensor device 27 can, in particular, be ultrasound sensors to measure a distance between the corresponding sensor and the corresponding object 7.

The sensor device 27 generates a sensor signal, in particular a plurality of individual sensor signals, in particular a plurality of individual distances to the respective object 7. This sensor signal or the individual signals are supplied to a control device 25 and processed by this. For example, only a signal path from one individual sensor of the sensor device 27, which is constructed in a door 17, in particular a left front side door, of the motor vehicle 1, is marked in FIG. 1. The door 17 is depicted in a partially open state in FIG. 1 and threatens to touch an object 7 or to collide with this. The risk of collision 5 can be understood as a driving of the entire motor vehicle 1 into the object 7 or only a hitting and/or collision of an outer skin of a moving part of the motor vehicle 1 or of the door 17 against and/or with one of the objects 7.

As can be recognized in FIG. 1, the partially opened door 17, if this is opened further, threatens to collide with the object 7 at a collision location 15. This risk of collision 5 can be relayed to the control device 25 in the form of the corresponding sensor signal and can be processed there.

In order to warn the user 3 of the motor vehicle 1 of this threatening collision, so of the risk of collision 5, an illumination state of an interior lighting device 11 of the motor vehicle 1 can be controlled. The control device 25, which processes corresponding output signals of the sensor device 27, undertakes this control. The interior lighting device 11 fundamentally serves for the purpose of an illumination of an interior 9 of the motor vehicle 1. Advantageously, this can also be used to signal and/or display the risk of collision 5.

According to one alternative, a certain illumination location 13 is illuminated by means of the control device 25 by means of the interior lighting device 11. Preferably, due to the selection of the certain illumination location 13 the collision location 15, at which the object 7 threatens to collide with the motor vehicle 1, can be symbolized for the user 3. In FIG. 1, a collision location 15 is marked with one of the objects 7, for example on a rear right mud flap. It can be recognized that the illumination location 13 is selected such that this lies between the user 3 and the object 7 with which the collision threatens at the collision location 15. This is symbolized by means of a viewing direction 39 in FIG. 1. The viewing direction 39 of the user 3 is directed to the object 7. Advantageously, the determined illumination location 13 is selected such that the viewing direction 39 is likewise shown in the direction of the determined illumination location 13 of the object 7 from which the risk of collision 5 originates. Advantageously, it can thus be shown to the user 3 of the motor vehicle 1 at which position the risk of collision 5 threatens, in particular the collision location 15.

According to a further alternative, a warning message 21 is additionally superimposed in an outer mirror 23 of the motor vehicle 1. The warning message 21 can be such a warning message that is also usually emitted by a blind spot assistant. Advantageously, this possibility to depict a warning message inside the outer mirror 23 in the situation of stationary traffic and/or of the maneuvering operation of the motor vehicle 1 can also be used to signal the risk of collision 5 of the operated door 17 with the corresponding objects 7.

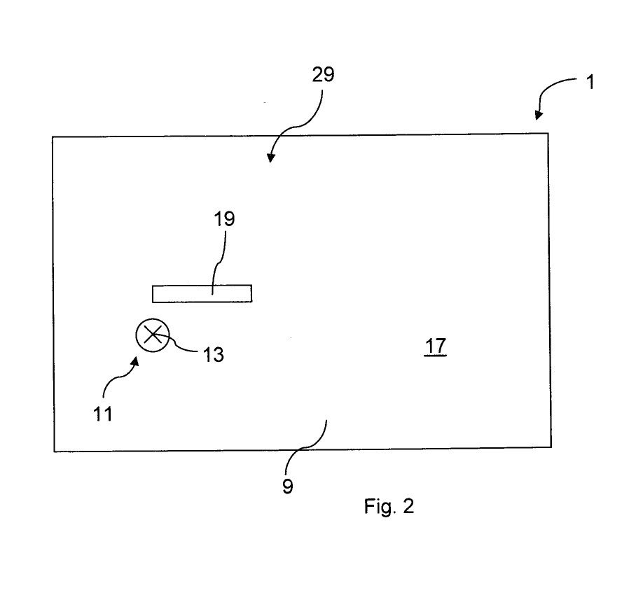

FIG. 2 shows a schematic view from inside of the door 17 of the motor vehicle 1 shown in FIG. 1.

The door 17 has an interior lining 29 and an operating device 19 to operate the door 17.

The interior lining 29 has a part of the interior lighting device 11, in particular as a part of an ambient lighting device and/or an indirect lighting device.

According to a preferred alternative, the illumination location 13 is selected such that it is adjacent to the operating device 19 and/or surrounds this. Advantageously, if the user operates the door 17 at the operating device 19 and thus triggers the risk of collision 5, he can be warned of the risk of collision 5, directly adjacent to and/or surrounding the actuating device 19. For this purpose, in particular, besides the selection of the illumination location 13, a color intensity, a light intensity and/or a color, in particular from red to green if the risk of collision 5 decreases or from green to red it the risk of collision 5 increases, can be controlled by means of the interior lighting device 11.

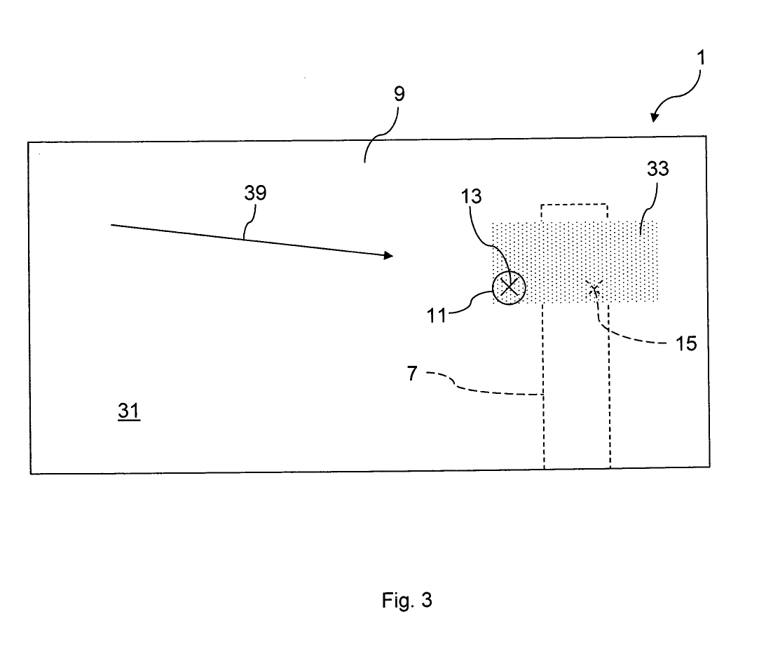

FIG. 3 shows a schematic view of a side wall 31 from inside the motor vehicle 1 shown in FIG. 1. The side wall 31 likewise has a part of the interior lighting device 11, in particular in the form of an illuminated area 33. The illuminated area 33 constitutes the determined illumination location 13. An object 7, from which the risk of collision 5 originates, and which is not visible from inside the motor vehicle 1 is marked in FIG. 3 by means of a dashed perimeter. Furthermore, the viewing direction 39 of the user 3 of the motor vehicle 1 is symbolized in FIG. 3. It can be recognized that the impression is created by means of the illuminated area 33, as if the side wall 31 were see-through, such that the object 7 from which the risk of collision 5 originates, can be located in a simple manner by the user 3, in particular also then if the user 3 has no actual view of the object 7. Advantageously, the anticipated collision location 15 with the object 7 can be signaled to the user 3 of the motor vehicle 1 by means of the illuminated area 33 of the interior lighting device 11, so via the illumination location 13.

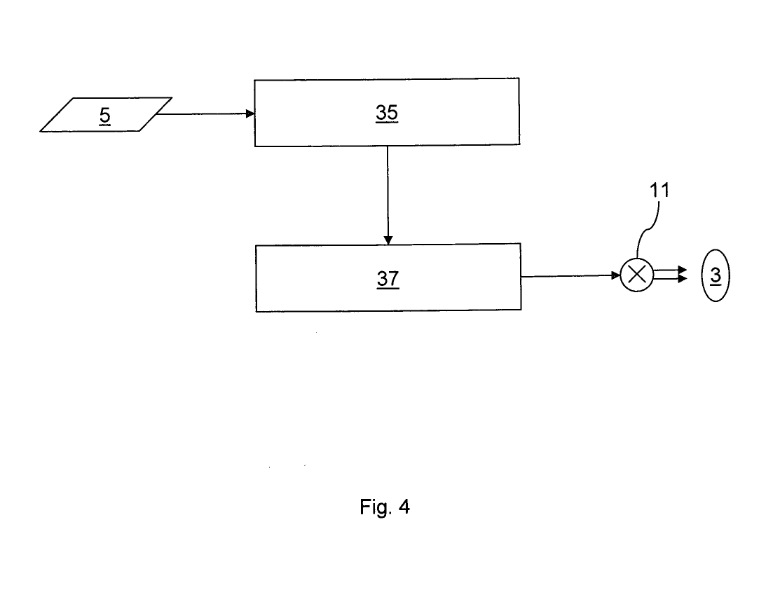

FIG. 4 shows a flow diagram of a method to warn the user 3 of the motor vehicle 1 depicted in FIGS. 1-3 of the risk of collision 5 of the motor vehicle 1 with one of the objects 7.

First, the risk of collision 5 is determined. This occurs by determining a magnitude of the risk of collision describing the risk of collision 5, in particular the plurality of the sensor signals able to be generated by means of the sensor device 27. In a first step 35, the risk of collision 5 is determined and processed accordingly, in particular by the control device 25.

In a second step 37, the user 3 is warned of the risk of collision 5 by means of the interior lighting device 11 provided to illuminate the interior 9 of the motor vehicle 1. This occurs, in particular, as has been described above, by changing the light color, in particular from green to red with increasing risk of collision and vice versa, in particular by changing the light intensity, in particular from weak to strong with increasing risk of collision, and vice versa, in particular changing and/or illuminating the determined illumination location 13 depending on the risk of collision 5, in particular by the display of the anticipated collision location 15 of the object 7 with the motor vehicle 1 by means of the illumination location 13, in particular of the illuminated area 33. In particular, the risk of collision arises from the operation of the door 17 of the motor vehicle, wherein the illumination location 13 is adjacent to and/or encloses the actuating device 19 to operation the door 17. In particular, alternatively or additionally, the superimposition of the warning message 21 in the outer mirror 23 of the motor vehicle 1 occurs.

The risk of collision 5 can have a magnitude of the risk of collision and/or can be described by this, in particular can have and/or describe the collision location 15, a distance of the motor vehicle 1 to the object 7, a time to contact (TTC), an approach speed to the object 7.

In particular, the object 7 in front of the door 17 is sensed by the sensor device 27 and a distance between the door 17 and the object 7 is displayed to the user 3 via the interior lighting device 11, in particular of a door handle illumination of the door 17. In particular, the color and/or intensity of the interior lighting device 11 changes depending on the distance. In particular, therefore a display of an approach to a collision detected via the sensor device 27 occurs via the color and/or intensity change of the interior lighting device 11, which in particular has an ambient illumination. Advantageously, damages to the motor vehicle 1 and/or to the object 7 can be prevented or at least reduced.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A method, comprising:
determining that there is a risk that a motor vehicle will collide with an object; and
warning a user of the motor vehicle that there is a risk that the motor vehicle will collide with the object using an interior lighting device configured to illuminate an interior of the motor vehicle.

12. The method of claim 12, further comprising:
changing a light color of the interior illumination device depending on the determined risk of collision.

13. The method of claim 12, wherein the changing of the light color involves changing the light color from a green shade to a red shade with increasing risk of collision and changing the light color from the red shade to the green shade with decreasing risk of collision.

14. The method of claim 11, further comprising:
changing a light intensity of the interior lighting device depending on the determined risk of collision.

15. The method of claim 14, further comprising:
changing the light intensity from weak to strong with increasing risk of collision; and
changing the light intensity from strong to weak with decreasing risk of collision.

16. The method of claim 11, further comprising:
changing or illuminating a determined illumination location depending on the determined risk of collision.

17. The method of claim 16, further comprising:
displaying an anticipated collision location of the object with the motor vehicle using the illumination location.

18. The method of claim 11, wherein the risk of collision originates from an operation of the door of the motor vehicle, the method further comprising:
selecting the determined illumination location that surrounds or is adjacent to an operating device for manual operation of the door.

19. The method of claim 11, further comprising:
superimposing a warning message in an outer mirror of the motor vehicle.

20. A motor vehicle, comprising:
an interior;
an interior lighting device arranged to illuminate the interior;
a control device configured to control an illumination state of the interior lighting device;
a sensor device configured to determine a risk of collision of the motor vehicle with an object,
wherein the control device is configured to control the illumination state depending on the determined risk of collision to warn the user of the risk of collision.
